(19) United States
(12) Patent Application Publication
(10) Pub. No.: US 2008/0000975 A1
(43) Pub. Date: Jan. 3, 2008

(54) Audible pattern switching indicator

(76) Inventors: Benjamin Hejl, Cherry Hill, NJ (US); John F. Bonanno, West Deptford, NJ (US); John T. Deal, Sewel, NJ (US); Nancy A. Smith, Philadelphia, PA (US)

Correspondence Address: NANCY A SMITH;METROLOGIC INSTRUMENTS, INC, 90 COLES ROAD, BLACKWOOD, NJ, 08012, US

(21) Appl. No.: 11/478,373

(22) Filed: Jun. 29, 2006

(51) Int. Cl. G06K 7/10

(52) U.S. Cl. 235/454

(57) ABSTRACT

A mode switch audible indication method, computer-readable medium, and apparatus are provided. In one embodiment, the method receives a switch scan mode signal and transmits an audio output signal in accordance with the switch scan mode signal. Thereafter, the method switches to a scan mode associated with the switch mode signal if the scan mode is not associated with the switch mode signal. In other embodiments, apparatuses and computer-readable medium, respectively, are also provided which perform similar features recited by the above method.

### BACKGROUND OF THE INVENTION

1. Field of the Invention

One or more aspects of the present invention generally relate to optical scanning systems and more particularly, to audio indication/confirmation of a selected mode of a light based symbol scanner.

2. Description of the Related Art

Laser based symbol (e.g., bar code) scanners have become widely used in many environments such as, for example, point-of-sale (“P.O.S.”) stations in retail stores and supermarkets, inventory management document tracking, and diverse data control applications. To meet the growing demands of this technological innovation, symbol readers of various types have been developed for sending symbols, reading symbols, and producing symbol character data for use as input in automated data processing systems.

In general, prior art laser-based symbol readers can be classified into two major categories—the first category, hand-held laser-based symbol readers; and the second, mounted laser-based symbol readers. Hand-held and mounted laser symbol readers typically include manually-actuated trigger mechanisms and/or automatically-activated (i.e., trigger-less using an infrared (“IR”) light beam or a low-power laser light beam) mechanisms for initiating laser scanning and bar code symbol reading operations. Scanners can include (and scan using) a group of substantially parallel scan lines or multiple groups of substantially parallel scan lines.

Sometimes the orientation of selected code with respect to an angle of the scan lines causes improper scanning of the selected code. For example, when a user attempts to scan a single line of bar code from a page of bar code, the orientation of the scan lines with respect to the bar code can erroneously cause multiple lines of bar code to be read (e.g., portions of adjacent scan lines read) and interpreted as a single line of bar code.

Therefore, there is a great need in the art for an improved laser scanning mechanism which avoids the shortcomings and drawbacks of prior art laser beam scanning apparatus and methodologies.

### SUMMARY

These and other deficiencies of the prior art are addressed by the present invention which generally relates to laser scanning systems and more particularly, to audio indication/confirmation of a selected mode of a laser based symbol scanner. In one embodiment, a method is provided which receives a switch scan mode signal and transmits an audio output signal in accordance with the switch scan mode signal. Thereafter, the method switches to a scan mode associated with the switch mode signal if the scan mode is not already associated with the switch mode signal. Embodiments which encompass apparatuses and a computer-readable medium which perform functions similar to the above described method are also provided.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only aspects of this disclosure and are therefore not to be considered limiting of its scope, for the invention may admit to other equally effective embodiments.

FIG. 1 is a perspective view of an illustrative scanning system used in accordance with aspects of this disclosure;

FIG. 2 is a perspective view of an exemplary symbol reading system used in accordance with aspects of this disclosure;

FIG. 3 is a close of view an exemplary scan mode depicted in FIG. 2;

FIG. 4 depicts an exemplary high level block diagram of a system in accordance with aspects of this disclosure;

FIG. 5 depicts a flow diagram of an illustrative method used in accordance with aspects of this disclosure; and

FIG. 6 depicts a high level block diagram of a computer architecture for performing aspects of this disclosure.

To facilitate understanding, identical reference numerals have been used, wherever possible, to designate identical elements that are common to the figures.

### DETAILED DESCRIPTION

In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of this invention.

For illustrative purposes only, the invention is described as capable of scanning bar code symbols. However that depiction is not intended in any way to limit the scope of the invention. It is appreciated that the invention can be used with scanners that scan other types of symbols.

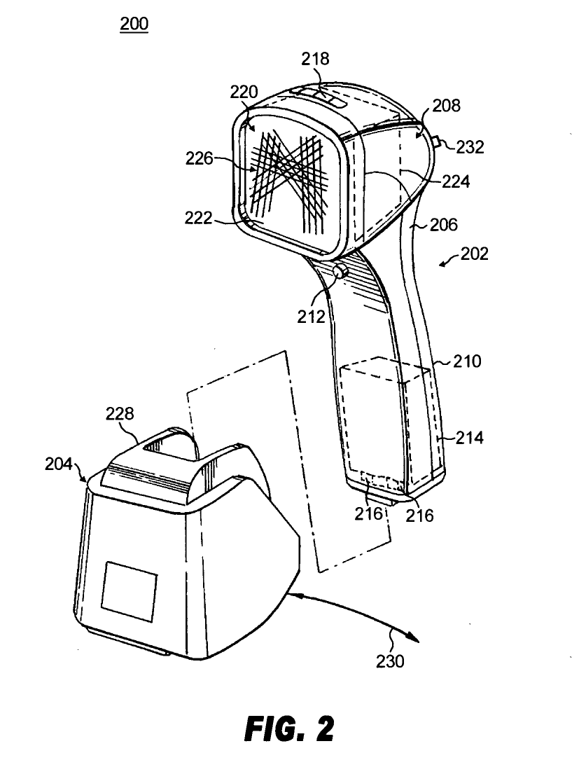

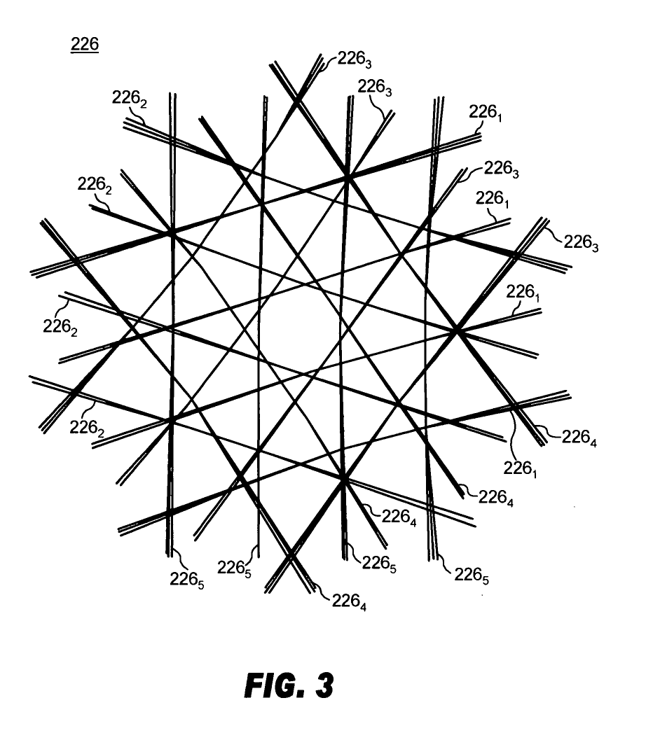

“Mode,” as used herein, describes a selection of a group of substantially parallel scan lines; or a selection of more than one group of substantially parallel scan lines. “Mode” can be any set (singular or multiple; and either substantially horizontal or on an angle) of scan lines. Illustratively, there can be a single set of substantially horizontal scan lines; a set which includes at least one group of angled scan lines (e.g., four groups of scan lines at forty-five degree angles); or a set which includes a combination of at least one group of substantially horizontal scan lines and at least one group of angled scan lines. For example, a scanner is in one mode if scanning is omni-directional (i.e., multiple groups of substantially parallel scan lines for scanning symbols oriented in various positions with respect to the scanner (examples of multiple groups of substantially parallel scan lines are shown in FIGS. 2 and 3)); in another mode if a single group of substantially parallel scan lines are selected; and yet in another mode, if at least two groups (but not as many groups as in the omni-directional mode) of substantially parallel scan lines are selected.

Symbol (e.g., bar code) scanners are often used in point-of-sale (“P.O.S.”) symbol scanning systems. Generally, P.O.S. scanning systems include a symbol scanner and a customer payment apparatus; or the symbol scanner, the customer payment apparatus, and a cashier terminal. It is appreciated that aspects of the present invention can be incorporated into either of these two types (as well as other) P.O.S. scanning systems.

It is also appreciated that the invention is not limited to the types of scanners disclosed herein. This document incorporates by reference all of the material disclosed within commonly owned and assigned U.S. Pat. No. 6,227,450 issued May 8, 2001 and entitled ELECTRONICALLY-CONTROLLED MECHANICALLY-DAMPED OFF-RESONANT LIGHT BEAM SCANNING MECHANISM AND CODE SYMBOL READERS EMPLOYING THE SAME; commonly owned and assigned U.S. Pat. No. 5,796,091 issued Aug. 18, 1998 and entitled AUTOMATIC HAND-SUPPORTABLE OMNIDIRECTIONAL LASER PROJECTION SCANNER WITH HANDLE-CONTROLLABLE PROJECTION AXIS; commonly owned and assigned U.S. Pat. No. 5,808,285 issued Sep. 15, 1998 and entitled PORTABLE CODE SYMBOL READING DEVICE WITH ONE-WAY WIRELESS DATA PACKET TRANSMISSION LINK TO BASE UNIT EMPLOYING CONDITION-DEPENDENT ACOUSTICAL SIGNALLING FOR DATA PACKET RECEPTION ACKNOWLEDGEMENT; commonly owned and assigned U.S. patent application Ser. No. 11/203,669 published Feb. 23, 2006 and entitled POINT OF SALE (POS) BASED BAR CODE READING AND CASH REGISTER SYSTEMS WITH INTEGRATED INTERNET-ENABLED CUSTOMER-KIOSK TERMINALS; U.S. Pat. No. 4,460,120 issued Jul. 17, 1984 and entitled NARROW BODIED, SINGLE- AND TWIN-WINDOWED PORTABLE LASER SCANNING HEAD FOR READING BAR CODE SYMBOLS; and U.S. Pat. No. 5,321,246 issued Jun. 14, 1994 and entitled BAR CODE SCANNER WITH RF COUPLING TO BASE TERMINAL AND AUTOMATIC TURN-OFF UPON DECODE, as if being set forth in its entirety herein.

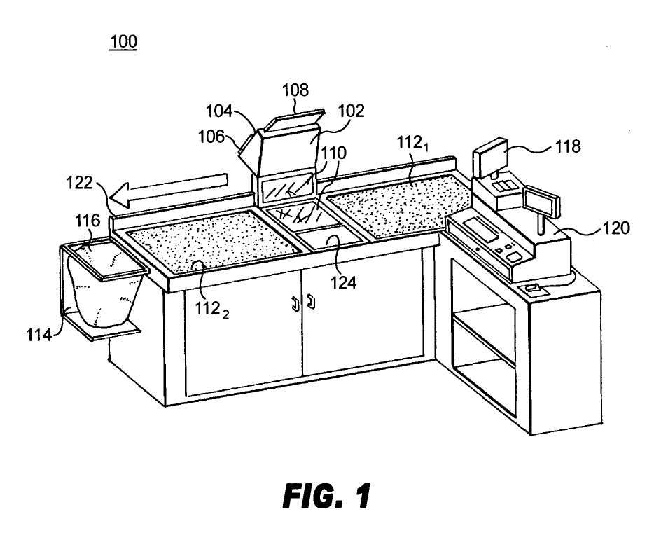

FIG. 1 is a perspective view of an illustrative P.O.S. scanning system 100 used in accordance with the invention. P.O.S. scanning system 100 includes a check-out stand 122 which supports an optical scanner 110, a customer payment apparatus 102, and a cashier terminal 120. Illustratively, the optical scanner 110 is depicted as a bi-optical-type (i.e., two scanners depicted as scanners 110₁ and 110₂ and collectively described herein as optical scanner 110) laser-scanning bar code symbol reading system.

Check out stand 122 includes an integrated electronic produce scale subsystem 124 juxtaposed to the optical scanner 110. Illustratively, the check-out stand 122 includes conveyors 112₁ and 112₂ on either side of the customer payment apparatus 102. An item may travel along conveyor 112₁ towards the optical scanner 110; and along conveyor 112₂ thereafter. As the item passes across the optical scanner 110, optical code located on the item is scanned (in accordance with the current scan mode of the optical scanner 110).

After the item is scanned, information (e.g., the name of the item and removal of the item from inventory) associated with the scanned symbols is displayed on display 118. Payment for the item may be made via the customer payment apparatus 102. The customer payment apparatus 102 accepts payment by cash and/or credit/debit card (via a magnetic strip reader 106). Optionally, the customer payment apparatus 102 includes an Automated Teller Machine (“ATM”) 104 and an ATM display 108.

In one embodiment, an end user (e.g., a cashier) at the cashier station 120 can select a scan mode for scanning items on the scanner 110. The user may switch the scan mode by scanning code associated with scan mode switching; or actuating a switch or series of switches. The switch(s) may be located in the check-out stand 122 or in a host system (not shown). When the system 100 receives the switch scan mode instruction an audible indication is provided that is associated with the selection.

For example, the cashier can scan code indicating to switch to a menu scan mode (i.e., a single group of substantially parallel scan lines) if the scanner is not already in menu scan mode. As a result of receiving the indicative code, an audible signal is generated indicating that the scanner is in menu scan mode. The audible signal can be a tone (or series of tones) or a spoken word (or series of words e.g., “menu scan mode”)). The audible signal provides confirmation that the user is switching to a desired scan mode. With greater control over the scan mode selection the cashier is able to scan easier. In addition, the scan mode may be switched by a host system (or other computer system) not shown in system 100.

FIG. 2 is a perspective view of another exemplary symbol reading system 200 used in accordance with the invention. The symbol reading system 200 includes a symbol reading device 202 and an optional base unit 204.

The symbol reading device 202 is within a housing 206. The housing 206 includes a head portion 208 and a handle portion 210. Inside of the housing 206 are a number of components. These components can be located either within (or on) the head portion 208 or within (or on) the handle portion 210. It is appreciated that although FIG. 2 depicts components as having a specific location within the housing 206 that depiction is for illustrative purposes only.

Some components included inside the housing 206 are a power supply 214 (e.g., a rechargeable battery); a scan engine 224; and circuitry (not shown) for performing various function such as, but not limited to, transmission of a carrier signal (e.g., an RF carrier signal and providing an audible signal). The scan engine 224 includes components for detecting and reading symbols. Visible from the exterior of the head portion 208 are optional indicator lights 218 and an activation switch 212 for manual user activation (i.e., for scanning code) of the symbol reading device 202. The indicator lights 218 can be a set of color-coded state indicator lights, for visually displaying a particular state in which the system 200 resides at any instant of time. Head portion 208 also includes a light transmission aperture 222. Covering the light transmission aperture 222 is a light transmission window 220.

In addition, the scanner 202 also includes an optional switch 230 for selecting a scan mode of the scanner 202. Upon actuating the switch 230, an audible signal is provided by the internal circuitry indicating the selected mode. Thereafter, the scanner 202 is switched to the selected scan mode in accordance.

Electrical power is supplied from power supply 214 to the circuitry and the symbol reading engine 224. When the scanner 202 is placed within the base unit 204, the power supply 214 is charged by contact points 216 and corresponding points (not shown) on the base unit 204. In addition to charging the scanner 202, the base unit 204 can (in various embodiments) provide a communications link with a host computer.

FIG. 3 is a close up view an exemplary scan mode 300 depicted in FIG. 2. Mode 300 is a selected omni-directional scan mode which is illustratively depicted as having five groups (226₁, 226₂, 226₃, 226₄, and 226₅ collectively referred to (and depicted) in FIG. 2 as scan lines 226) of substantially parallel scan lines. It is appreciated that although the omni-directional mode 300 is depicted as having five groups of substantially parallel lines 226 more or less groups of scan lines can be included.

A different mode may be selected (e.g., by an end user) which has a different number of groups of scan lines. For example, a mode can be selected where only one of the groups 226₁, 226₂, 226₃, 226₄, or 226₅ is utilized. In another example, a scan mode can be selected where at least two of the groups 226₁, 226₂, 226₃, 226₄, or 226₅ are utilized.

In addition, FIG. 3 depicts each group 226 as having four scan lines. However, that depiction is for illustrative purposes only. Each group 226 may contain more or less scan lines. For example, some scanners produced by Metrologic Instruments, Inc. of Blackwood, N.J. have a single scan line which utilizes a spinning polygon and mirrors to produce twenty unique scan lines. Some of the scan lines can be made more visible than other scan lines. By knowing where the polygon is, its rotation more or less current to the laser can brighten or dim scan lines accordingly. Optionally, if code is scanned in a particular orientation, only scan lines in that particular orientation can be illuminated. For example, when you want to scan in menu scanning mode, it is often desirable to aim the scan line at a symbol (e.g., bar code) and/or to see which scan line is scanning.

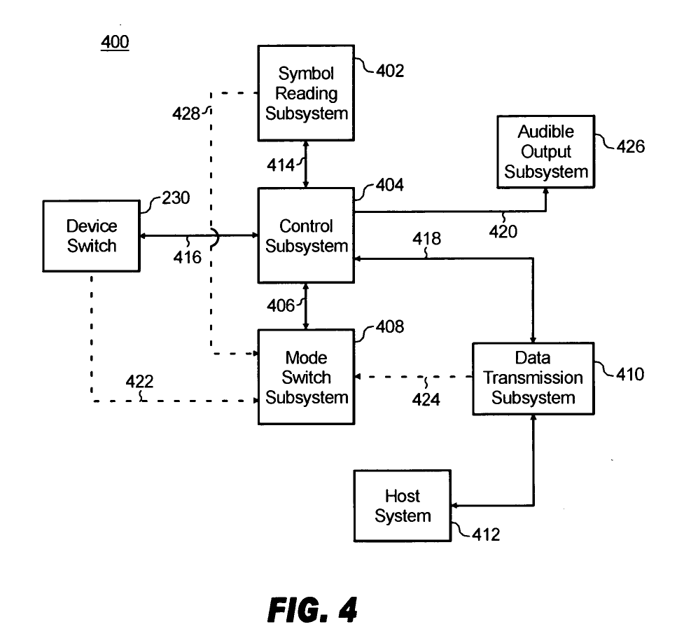

FIG. 4 depicts an exemplary high level block diagram of a system 400. The system 400 includes a symbol reading subsystem 402, a control subsystem 404, a device switch 230, a mode switch subsystem 408, a data transmission subsystem 410, a host system 412, and an audible output subsystem 420. Although the systems 200 and 400 (in FIGS. 2 and 4 respectively) are depicted as including the device switch 230, it is appreciated that the device switch 230 is optional and not necessary.

An instruction to change the scan mode of the symbol reading subsystem 402 can be transmitted by any one of the subsystems 402,404, 408, 410, or 412; or the device switch 230. For example;
1. when the device switch 230 is actuated, a switch mode scan instruction is transmitted towards the control subsystem 408 via bi-directional transmission path 416; and/or optionally towards the mode switch subsystem 408 via transmission path 422;
2. when the symbol reading subsystem 402 reads code associated with a switch scan mode instruction, the symbol reading subsystem transmits the switch scan mode instruction towards the control subsystem via bi-directional transmission path 414; and/or optionally towards the mode switch subsystem via communications path 420; and
3. when the switch scan mode instruction is initiated from the host system 412, the switch scan mode instruction is transmitted utilizing the data transmission subsystem 410 towards the control subsystem 404 via a bi-directional communications path 418; and/or optionally towards the mode switch subsystem 408 via communications path 424.

Some of the functions performed, by the control subsystem 404, are the transmission and reception of instructions. When the control subsystem 404 receives the information regarding a switch in the scan mode from the mode switch subsystem 408 without having first received switch mode information from the device switch 230, the symbol reading subsystem 402, or the host system 412, the control subsystem 404 will transmit information towards the audible output subsystem 426 as described below. However, when the control subsystem 404 receives a switch mode signal from the device switch 230, the symbol reading subsystem 402, or the host system 412, the control subsystem 404 will forward the information towards the mode switch sub system 408 via bi-directional communications path 406; and transmit information associated with the selected scan mode towards the audible output subsystem 426 (as described below). When the mode switch subsystem 408 receives the switch scan mode signal the mode switch subsystem 408 switches the scan mode.

The transmission paths 412, 418, and 424 utilized by the data transmission subsystem 410 can be a wired communications path (e.g., utilizing an RS 232 connection) and/or a wireless communications path (e.g., a radio frequency transmission or infrared transmission; or utilize various communications protocols (e.g., Bluetooth or SONET)).

In various embodiments, the data transmission subsystem 410 can be configured to also receive switch scan mode instructions from existing systems; and third party systems. For example, the present invention can be subsequently added to scanning systems and/or computer systems already being utilized; prepackaged with a scanning system distributed by another manufacturer; or prepackaged with a computer system distributed by another manufacturer.

When the switch scan mode instruction is received by the data transmission subsystem 410, the data transmission subsystem 410 transmits the switch scan mode instruction towards the control subsystem 404 via communications path 418; and/or towards the mode switch subsystem 408 via communications path 424.

When the mode switch subsystem 408 receives the switch scan mode signal from the device switch 230; the symbol reading subsystem 402; the control subsystem 404; or the host system 412, the mode switch subsystem 408 switches the scan mode of the symbol reading subsystem 402. Thereafter, the mode switch subsystem 408 sends the selected scan mode information towards the control subsystem 404 via bi-directional communication path 406. The control subsystem 404 sends the selected scan mode information towards the audible output subsystem 426 via communication path 420.

The audible output subsystem transmits an audible signal associated with the selected scan mode. The audible signal thus informs the user of the selected scan mode. The audible signal can be an audible tone or at least one word (e.g., diagonal scanning or omni-directional scanning, or menu scanning). The words used can be in a language desired by the end user. The audible output subsystem 426 includes a transducer or speaker in addition to other circuit elements for interpreting the information received from the control subsystem 404 and providing the selected scan mode audible indication.

Different scanning systems will sometimes use different circuit boards. It is appreciated that the functions performed by the subsystems (402, 404, 408, 410, 426, and 430) described herein can be incorporated onto the same circuit board or a combination of circuit boards.

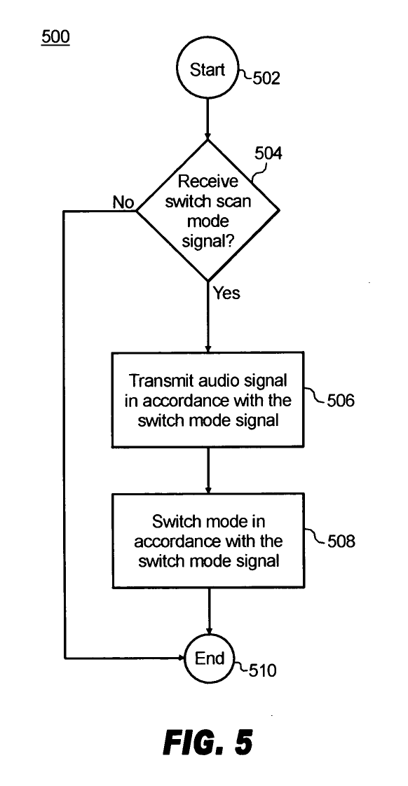

FIG. 5 is an embodiment of a flow diagram of a method 500 in accordance with the invention. The method 500 begins at step 502 and proceeds step 504.

At step 504 a determination is made whether a switch mode instruction signal is received. As explained above, the switch mode instruction signal may be initiated by at least one of a physical switch (e.g., button 230) on the scanner 202, a signal received from the host system 412, optical symbols read by the scanner 202, and a computer system other than the host system 412. If, at step 504 a positive determination is made (i.e., a switch mode signal is received) a signal is transmitted towards the audible output subsystem 426. Thereafter, the method 500 proceeds toward step 506.

At step 506, the scan mode of the scanner 202 is switched in accordance with the switch mode instruction and the audible signal generated by the audible output subsystem 426.

If, at step504, a negative determination is made, the method 500 proceeds to and ends at step 510.

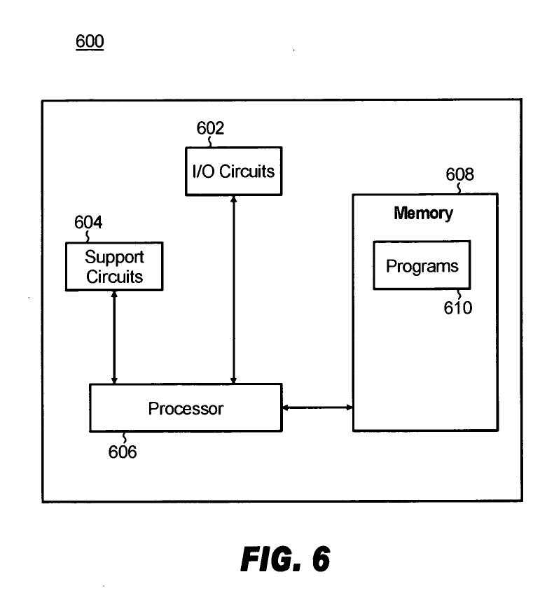

FIG. 6 depicts a high level block diagram of an embodiment of a controller 600, as part of electronic circuitry, suitable for use in providing an audible indicator in accordance with a selected operation mode. The controller 600 of FIG. 6 comprises a processor 606 as well as a memory 608 for storing control programs and the like. The processor 606 cooperates with conventional support circuitry 604 such as power supplies, clock circuits, cache memory and the like as well as circuits that assist in executing the software routines stored in the memory 608. As such, it is contemplated that some of the process steps discussed herein as software processes may be implemented within hardware, for example, as circuitry that cooperates with the processor 606 to perform various steps. The controller 600 also contains input-output circuitry 602 that forms an interface between the various functional elements communicating with the controller 600. For example, the controller 600 communicates with at least one of a device switch 230, a symbol reading subsystem 402 (or device 202), a mode switch subsystem 408, and a host system 412 to receive information regarding a switch scan mode. In various embodiments, the controller 600 also communicates with a data transmission subsystem 410.

Although the controller 600 of FIG. 6 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

It has been described herein that the audible indicator is generated prior to switching the scan mode however that description is for illustrative purposes only. It is appreciated that the scan mode can be switched prior to or simultaneous with audible indication.

Although various embodiments that incorporate the teachings of the present invention have been shown and described in detail herein, those skilled in the art can readily devise many other varied embodiments that still incorporate these teachings.

We claim:

1. A method comprising:
receiving a switch scan mode signal;
transmitting a mode output signal in accordance with said switch scan mode signal; and
switching to a scan mode associated with said switch mode signal when said scan mode is not in accordance with said switch mode signal.

2. The method of claim 1 wherein said switch mode signal is associated with a plurality of substantially parallel scan lines.

3. The method of claim 1 wherein said switch mode signal is associated with at least one group of substantially parallel scan lines.

4. The method of claim 1 wherein said scan mode is selected from a plurality of scan modes.

5. The method of claim 1 wherein said mode output signal is an audio output signal.

6. The method of claim 5 wherein said audio output signal is at least one audible tone.

7. The method of claim 5 wherein said audio output signal is at least one word.

8. The method of claim 1 wherein said switch scan mode signal is from a group comprising one of:
a first signal derived from actuating a physical switch;
a second signal derived from scanning at least one symbol;
a third signal transmitted using a communication protocol; and
a fourth signal transmitted from a host computer.

9. A computer-readable medium having stored thereon a plurality of instructions, the plurality of instructions including instructions which, when executed by a processor, cause the processor to perform the steps comprising of:
receiving a switch scan mode signal;
transmitting a mode output signal in accordance with said switch scan mode signal; and
switching to a scan mode associated with said switch mode signal when said scan mode is not in accordance with said switch mode signal.

10. The computer-readable medium of claim 9 wherein said switch mode signal is associated with a plurality of substantially parallel scan lines.

11. The computer-readable medium of claim 9 wherein said switch mode signal is associated with at least one group of substantially parallel scan lines.

12. The computer-readable medium of claim 9 wherein said scan mode is selected from a plurality of scan modes.

13. The computer-readable medium of claim 9 wherein said mode output signal is an audio output signal.

14. The computer-readable medium of claim 13 wherein said audio output signal is at least one audible tone.

15. The computer-readable medium of claim 13 wherein said audio output signal is at least one word.

16. The computer-readable medium of claim 9 wherein said switch scan mode signal is from a group comprising one of:
a first signal derived from actuating a physical switch;
a second signal derived from scanning at least one symbol;
a third signal transmitted using a communication protocol; and
a fourth signal transmitted from a host computer.

17. Apparatus comprising:
an input adapted to receive a switch scan mode signal;
an output adapted to transmit a mode output signal in accordance with said switch scan mode signal; and
a mode switch adapted to switch to a scan mode associated with said switch mode signal when said scan mode is not in accordance with said switch mode signal.

18. The apparatus of claim 17 wherein said switch mode signal is associated with a plurality of substantially parallel scan lines.

18. The apparatus of claim 17 wherein said switch mode signal is associated with at least one group of substantially parallel scan lines.

19. The apparatus of claim 17 wherein said scan mode is selected from a plurality of scan modes.

20. The apparatus of claim 17 wherein said mode output signal is an audio output signal.

21. The apparatus of claim 20 wherein said audio output signal is at least one audible tone.

22. The apparatus of claim 20 wherein said audio output is at least one word.

23. The apparatus of claim 17 wherein said switch scan mode signal is from a group comprising one of:
a first signal derived from actuating a physical switch;
a second signal derived from scanning at least one symbol;
a third signal transmitted using a communication protocol; and
a fourth signal transmitted from a host computer.

24. The apparatus of claim 17 further comprising one of a transducer and a speaker.

25. A processor comprising:
a first subsystem configured to receive a mode switch signal and transmit a mode output signal in accordance with said switch mode signal; and
a second subsystem in communication with said first subsystem and configured to switch to a scan mode in accordance with said switch mode signal.

26. The processor of claim 25 wherein said mode output signal is an audio output signal.

27. The processor of claim 25 wherein said switch mode signal is one of:
a first signal derived from actuating a physical switch;
a second signal derived from scanning at least one symbol;
a third signal transmitted using a communication protocol; and
a fourth signal transmitted from a host computer.
